(19) United States
(12) Patent Application Publication
(10) Pub. No.: US 2002/0048447 A1
(43) Pub. Date: Apr. 25, 2002

(54) Reproduction apparatus, reproduction method, image processing apparatus, and image processing method

(76) Inventor: Shinji Onishi, Kanagawa (JP)

Correspondence Address: ROBIN BLECKER & DALEY, 2ND FLOOR, 330 MADISON AVENUE, NEW YORK, NY, 10017, US

(21) Appl. No.: 09/957,226

(22) Filed: Sep. 20, 2001

(30) Foreign Application Priority Data
Sep. 25, 2000 (JP) 290407/2000

(51) Int. Cl. H04N 9/74

(52) U.S. Cl. 386/4

(57) ABSTRACT

A reproduction apparatus including a reproduction unit for reproducing digital moving picture data and program data recorded on a recording medium, the program data indicating a procedure for reproducing the digital moving picture data, and a digital interface for outputting the digital moving picture data and the program data reproduced by the reproduction unit to the external of the apparatus. This construction allows the digital moving picture data outputted to the external of the apparatus to be properly reproduced according to the reproduction procedure indicated by the program data.

### BACKGROUND OF THE INVENTION

1. Field of the Invention

The present invention relates to a reproduction apparatus, a reproduction method, an image processing apparatus, and an image processing method.

2. Related Background Art

Conventionally, there have been devised a variety of techniques of compressing and encoding image data and audio data. In particular, the MPEG-2 (Moving Picture Experts Group 2) standard is currently widely known. Also, the system specification of the MPEG-2 defines a data transfer method based on transport streams (hereinafter referred to as the “MPEG-2 TSs”) each of which is composed of fixed length packets called transport stream packets. This method is suitable for data transfer over a network or the like and therefore is used for digital television broadcasting or the like.

Also, in recent years, there have been proposed techniques of recording moving picture data and audio data of MPEG-2 TSs (hereinafter collectively referred to as the “MPEG-2 TS data”) onto magnetic tapes, hard disks, magneto-optical disks, and the like.

Further, as a technique of regulating the reproduction order of a plurality of data and establishing synchronization among these data in a system that reproduces multimedia data including audio data and image data, a language called SMIL (Synchronized Multimedia Integration Language) was disclosed as a recommendation by the W3C (World Wide Web Consortium). This language is based on an XML (Extensible Markup Language) and provides a function of performing synchronized reproduction of files by specifying these files using URI (Uniform Resource Identifiers).

Meanwhile, many recent digital AV devices are equipped with digital interfaces, so that it is now possible to output audio data and moving picture data to digital devices, such as PCs (personal computers), via the digital interfaces.

A typical digital interface used for AV devices is an digital interface in conformity with the IEEE1394-1995 standard, according to which data is transferred using two transfer modes: an asynchronous transfer mode and an isochronous transfer mode. In the isochronous transfer mode, broadcast transfer is performed in which data is transferred by specifying transmission channels. By transferring real-time data having time dependency (such as audio data and moving picture data) in the isochronous transfer mode, it becomes possible to perform data transfer where isochronism is ensured. In the asynchronous transfer mode, asynchronous transfer of one-to-one node designation type is fundamentally performed. Therefore, this asynchronous transfer mode is suitable for the transfer of data having no time dependency, such as text files. In this transfer mode, data is transferred to destinations with reliability.

Also, a standard called “IEC 61883-4: Consumer audio/video equipment-Digital interface-Part 4:MPEG-2 TS data transmission” has been recently known. This standard was created to transmit MPEG-2 TS data from IEEE1394-1995 standard compliant digital interfaces, and stipulates the procedure for transmitting MPEG-2 TS data in the isochronous transfer mode of the IEEE1394-1995 standard.

A packet structure for transmitting MPEG-2 TS data in the isochronous transfer mode of the IEEE1394-1995 standard is described below with reference to FIGS. 5A and 5B.

The packet shown in FIG. 5A is data called a source packet. Moving picture data based on the MPEG2 standard is variable length data, although this data sequence is divided into a plurality of pieces of 188-byte data. Each piece of 188-byte data is called a transport stream packet, with a 4-byte source packet header being added to the head of the transport stream packet. This 192-byte data is dealt as a source packet. Each piece of data obtained by diving the source packet into eight equal parts is called a data block.

The packet shown in FIG. 5B is an isochronous packet where a common isochronous packet header that shows the attribute of data in the packet is set at the head of the packet and MPEG-2 data is arranged as a payload to follow the common isochronous packet header. This payload is of variable length, and contains zero, one, two, or four data blocks or source packets whose number is an integer.

With reproduction program information written in the SMIL described above, it becomes possible to simultaneously reproduce a plurality of MPEG-2 TS data.

When a plurality of MPEG-2 TS data reproduced according to such program information are outputted through via a digital interface, however, there has been no means for recognizing data specified by the program information among the outputted data on the reception side.

This causes a problem that audio and moving picture data reproduced according to program information cannot be outputted to an external device (a PC, for instance) via a digital interface to present the audio and moving picture data.

### SUMMARY OF THE INVENTION

The present invention has been made in the light of the above-mentioned problem, and therefore has an object of making it possible to properly present data reproduced according to program information even when the reproduced data is outputted to an external device.

According to a preferred embodiment of the present invention, there is disclosed a reproduction apparatus comprising:

reproduction means for reproducing digital moving picture data and program data recorded on a recording medium, the program data indicating a procedure for reproducing the digital moving picture data; and

digital interface means for outputting the digital moving picture data and the program data reproduced by the reproduction means to the external of the apparatus.

According to another preferred embodiment of the present invention, there is disclosed an image processing apparatus comprising:

digital interface means for inputting program data and digital moving picture data, the program data indicating a procedure for reproducing the digital moving picture data, and the digital moving picture data having been reproduced according to the procedure indicated by the program data before being inputted;

processing means for processing the digital moving picture data inputted by the digital interface means; and

control means for controlling a processing operation of the processing means according to the program data inputted by the digital interface means.

According to still another preferred embodiment of the present invention, there is disclosed a reproduction method comprising:

a step of reproducing digital moving picture data and program data recorded on a recording medium, the program data indicating a procedure for reproducing the digital moving picture data; and

a step of outputting the reproduced digital moving picture data and program data to the external of an apparatus via a digital interface means.

According to yet another preferred embodiment of the present invention, there is disclosed an image processing method comprising:

a step of inputting program data and digital moving picture data via a digital interface means, the program data indicating a procedure for reproducing the digital moving picture data, and the digital moving picture data having been reproduced according to the procedure indicated by the program data before being inputted; and

a step of processing the digital moving picture data inputted via the digital interface means according to the program data inputted via the digital interface means.

Still other objects of the present invention, and the advantages thereof, will become fully apparent from the following detailed description of the embodiments.

### BRIEF DESCRIPTION OF THE DRAWINGS

In the accompanying drawings:

FIG. 1 is a block diagram showing a construction of a reproduction system to which the present invention is applied;

FIG. 2 shows a state of program information dealt with by the system shown in FIG. 1;

FIG. 3 shows another state of the program information dealt with by the apparatus shown in FIG. 1;

FIG. 4 shows still another state of the program information dealt with by the apparatus shown in FIG. 1;

FIGS. 5A and 5B show a state of data transferred by the apparatus shown in FIG. 1;

FIG. 6 shows another state of the data transferred by the apparatus shown in FIG. 1;

FIG. 7 is a block diagram showing another construction of the reproduction system to which the present invention is applied;

FIG. 8 shows a state of program information dealt with by the system shown in FIG. 7;

FIG. 9 shows another state of the program information dealt with by the system shown in FIG. 1 or FIG. 7; and

FIG. 10 shows still another state of the program information dealt with by the system shown in FIG. 1 or FIG. 7.

### DETAILED DESCRIPTION OF THE PREFERRED EMBODIMENTS

The preferred embodiments of the present invention will now be described in detail hereinafter with reference to the accompanying drawings.

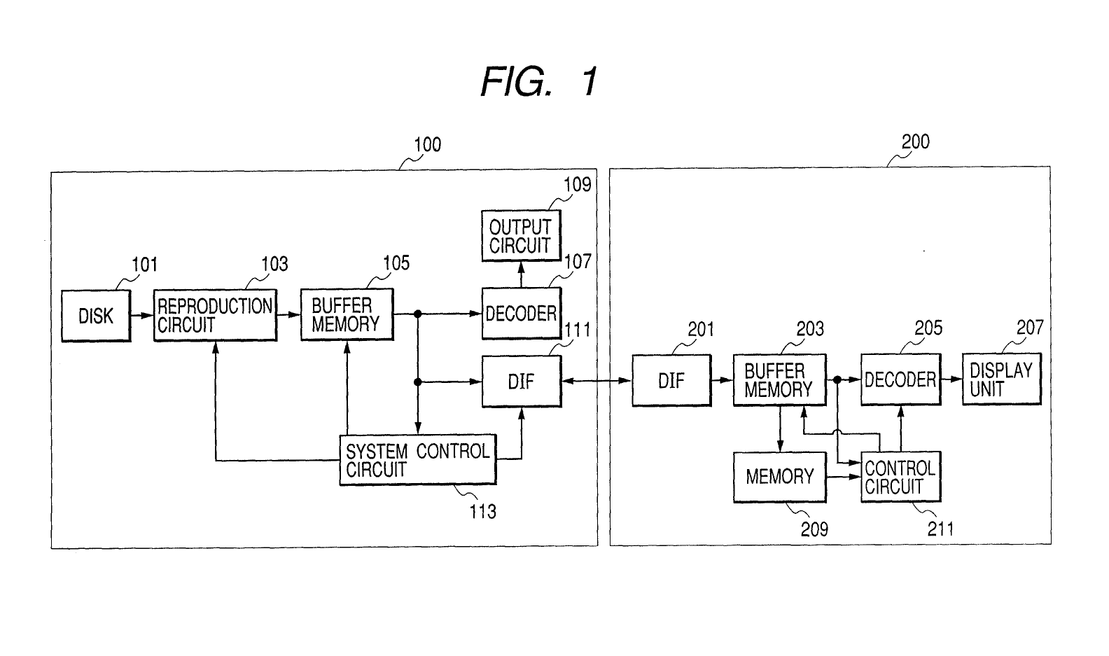

FIG. 1 is a block diagram showing the construction of a reproduction system according to the first embodiment of the present invention. The reproduction system of this embodiment reproduces MPEG-2 TS audio and moving picture data recorded on a magneto-optical disk. In this embodiment, in addition to the audio and moving picture data, program information for controlling the reproduction procedure of these data is also recorded on the disk.

The system shown in FIG. 1 includes a reproduction apparatus 100 and a PC 200, with the PC 200 having a function of controlling a reproduction operation according to the program information reproduced by and outputted from the reproduction apparatus 100.

First, an ordinary reproduction operation of the reproduction apparatus 100 is described.

A reproduction circuit 103 includes a known optical pickup, reproduces audio and moving picture data recorded on a disk 101, and outputs the reproduced data to a buffer memory 105. The buffer memory 105 outputs the reproduced data to a decoder 107 and a digital interface (hereinafter referred to as the “DIF”) 111. The decoder 107 decodes the reproduced data and outputs the decoded data to an output circuit 109. The output circuit 109 converts the decoded data outputted from the decoder 107 into an analog signal, and outputs the analog signal to an external device such as a monitor.

The reproduction apparatus 100 of this embodiment reproduces audio and moving picture data based on the MPEG-2 TS standard. Note that, a plurality of audio and moving picture data based on the standard are recorded on the disk 101 as files. The disk 101 also stores program information, and the reproduction apparatus 100 performs a reproduction operation according to this program information.

That is, in the case where a reproduction operation is performed according to the program information, a system control circuit 113 instructs the reproduction circuit 103 to reproduce the program information recorded on the disk 101, and stores the reproduced program information in a memory built in the system control circuit 113 via the buffer memory 105.

The system control circuit 113 then instructs the reproduction circuit 103 to reproduce the audio and moving picture data recorded on the disk 101 according to the procedure and timings specified by the program information.

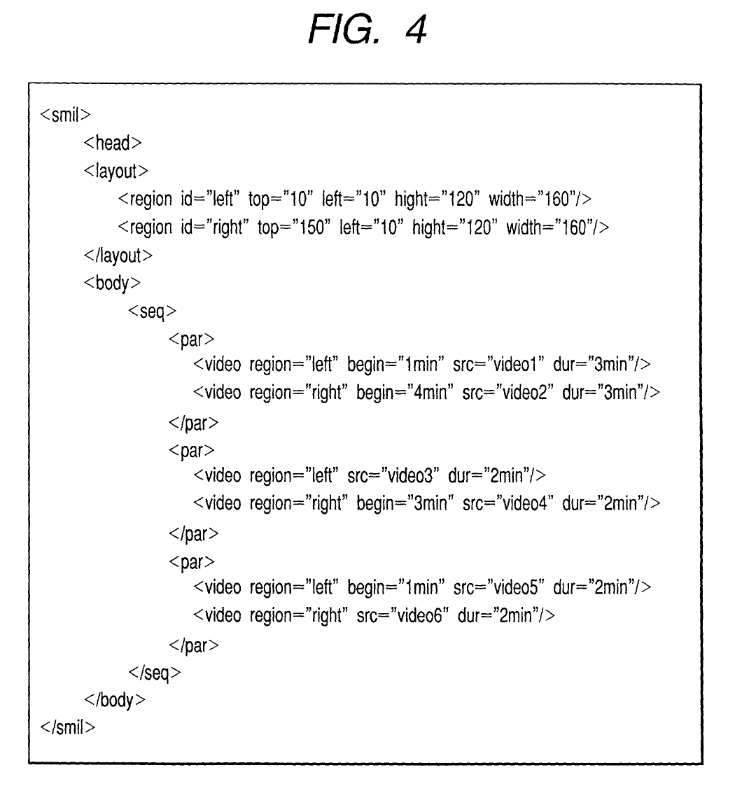

An example of the program information is shown in FIG. 4.

In this embodiment, six MPEG-2 moving picture files “video1”, “video2”, “video3”, “video4”, “video5”, and “video6” are recorded on the disk 101. Also, the program information shown in FIG. 4 is written in the SMIL and is used to synchronously reproduce these files.

The part between “<layout>” and “</layout>” defines two regions on a screen, in each of which moving picture data is displayed. The regions are specified by region parameter values “left”and “right” given in the following part in which reproduction is specified.

The part between “<par>” and “</par>” designates simultaneous and parallel reproduction, while the part between “<seq>” and “</seq>” designates sequential reproduction. First, data designated by the part between the first pair of “<par>” and “</par>” is simultaneously reproduced. When the reproduction of this data is completed, data designated by the part between the second pair of “<par>”and “</par>” is reproduced. Finally, data designated by the part between the third pair of “<par>” and “</par>” is reproduced, and this program is ended.

The files “video1”and “video2”are selected in the part between the first pair of “<par>” and “</par>”. It is specified that the reproduction and display of the file “video1” should be started in the “left” region from a point at which one minute has passed from the head of the file. It is also specified that the reproduction and display of the file “video2” should be started in the “right” region from a point at which four minutes have passed from the head of the file. The reproduction of these files is started from the specified points respectively and is performed in parallel. Data having the reproduction time length (three minutes, in this example) specified by a “dur” parameter is reproduced, and the synchronous reproduction is ended.

In the same manner, files specified in the part between the second and third pairs of “<par>” and “</par>” are synchronously reproduced. If the part specifying files to be reproduced does not specify any value for a “begin” parameter, the specified files are reproduced from the heads thereof respectively.

As described above, by specifying program information like that shown in FIG. 4, it becomes possible to easily perform editing operations without changing moving picture data, audio data, and the like held on a recording medium.

The following description concerns the operation of the PC 200 when data reproduced by the ordinary reproduction operation is outputted via the DIF 111. Note that, in this embodiment, the DIFs 111 and 201 perform data transmission and reception in accordance with the IEEE1394-1995 standard.

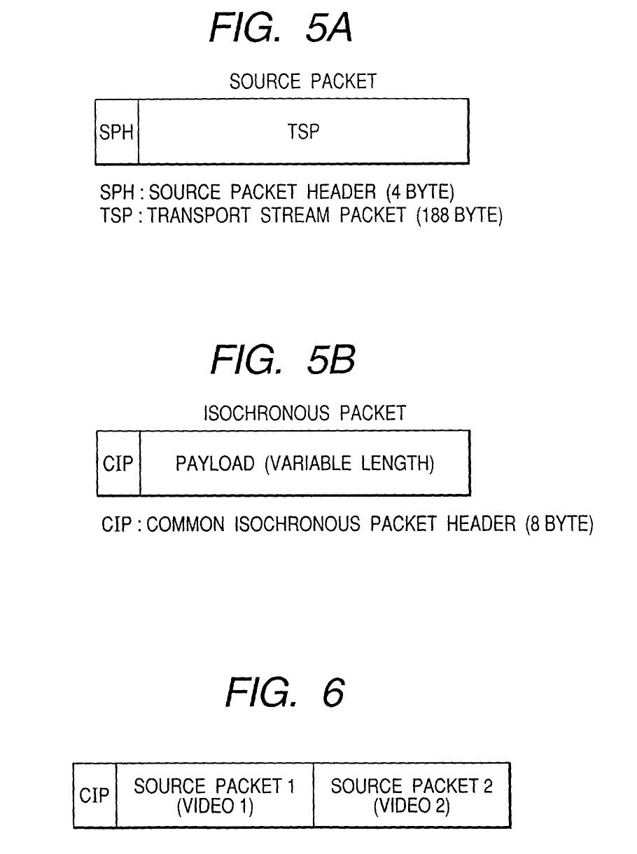

When an audio and moving picture data specified by the ordinary reproduction operation is to be outputted to the PC 200, an isochronous channel that is necessary to transfer the reproduced data between the DIFs is first secured. Then, in the isochronous transfer mode, the reproduced data is outputted from the DIF 111 to the DIF 201 in the format shown in FIG. 5B.

On receiving the reproduced data from the DIF 111, the DIF 201 removes a CIP header part from the received data, and outputs only MPEG-2 TS data to a buffer memory 203. On receiving the MPEG-2 TS data from the DIF 201, the buffer memory 203 outputs the received data to a decoder 205. The decoder 205 decodes the MPEG-2 TS data received from the buffer memory 203 and outputs the decoded data to a display unit 207.

The following description concerns the case where audio and moving picture data reproduced according to program information is transferred to the PC 200 via the DIF 111 and is reproduced in the PC 200 according to the program information.

The system control circuit 113 first instructs the reproduction circuit 103 to reproduce program information shown in FIG. 4, from on the disk 101, and stores the reproduced program information in the memory built in the system control circuit 113. The system control circuit 113 then checks the contents of the program information, and at the same time detects the number of audio and moving picture data that should be simultaneously transferred.

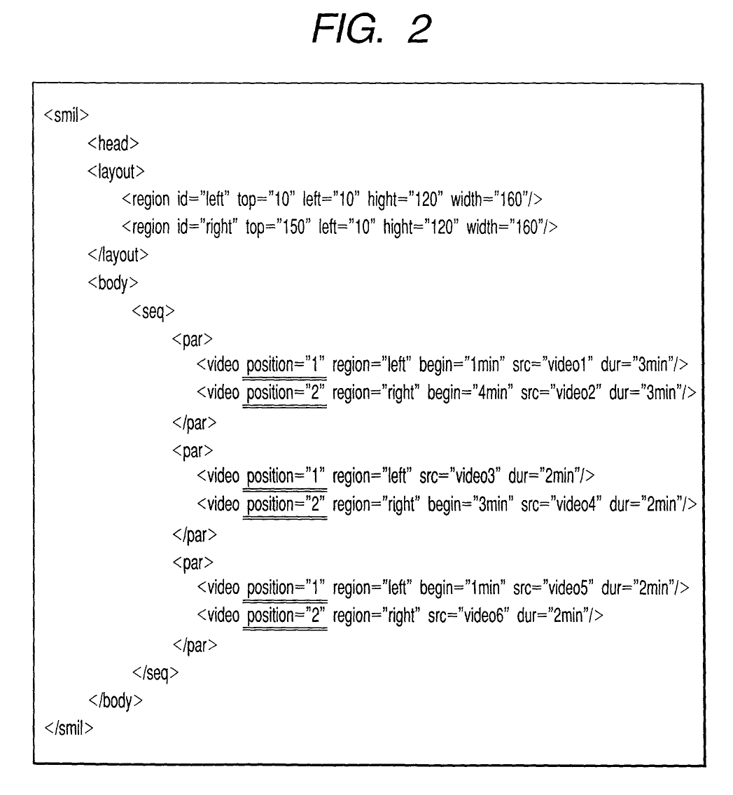

According to the detection result, the system control circuit 113 rewrites the reproduced program information in the manner shown in FIG. 2. In FIG. 2, a “position” element is added to each part specifying a each moving picture data. As will be described later, this “position” element defines the location of a corresponding moving picture data in a plurality of source packets contained in a single isochronous packet to be transferred. More specifically, in the case of FIG. 2, the “position” element indicates that each of the video 1 data, video3 data, and video5 data belongs to the first source packet and each of the video2 data, video4 data, and video6 data belongs to the second source packet in the isochronous packet to be transported.

Then, as in the case of the ordinary reproduction, the system control circuit 113 secures an isochronous channel, which is necessary to transfer data between the DIFS, by controlling the DIF 111. After securing the channel, the system control circuit 113 transmits the program information via the DIF 111. At this time, as necessary, the system control circuit 113 makes a preparation for transferring the program information between the DIF 111 on the transmission side and the DIF 201 on the reception side, and then transfers the program information in the asynchronous transfer mode.

In the PC 200, the program information received by the DIF 201 is stored in the buffer memory 203. On detecting that the program information has been written in the buffer memory 203, a control circuit 211 stores the program information in a memory 209. The control circuit 211 then analyzes the contents of this program information and notifies the DIF 111 of the reproduction apparatus 100 that the analysis is completed, via the DIF 201.

After transmitting the program information shown in FIG. 2, the system control circuit 113 waits for a notification that the analysis of the program information by the PC 200 is completed, to be transmitted from the DIF 201. On receiving this notification, the system control circuit 113 starts to reproduce and transmit data according to the program information shown in FIG. 2.

In this embodiment, two moving picture data (moving picture files) are simultaneously reproduced. By controlling the DIF 111, the system control circuit 113 creates a source packet for each of these two files, arranges these source packets in the same isochronous packet in the order shown by the program information, and transmits the isochronous packet. FIG. 6 shows the structure of an isochronous packet in the case where the video1 data and the video2 data are transmitted according to the program information shown in FIG. 2. In FIG. 6, a common isochronous packet header is set at the head of the isochronous packet and source packets containing the video1 data and the video2 data are set to follow the common isochronous packet header.

Next, the DIF 201 of the PC 200 extracts each source packet from the received isochronous packet according to the program information received in advance, and outputs each extracted source packet to the buffer memory 203.

The control circuit 211 detects the contents of data stored in the buffer memory 203, selects necessary data according to the reproduction procedure shown by the program information stored in the memory 209, and outputs the selected data to the decoder 205. More specifically, the video1 data, video3 data, and video5 data are each transmitted as the first half source packet shown in FIG. 6, and the video2 data, video4 data, and video6 data are each transmitted as the latter half source packet. Therefore, the control circuit 211 detects these transmitted data and outputs them to the decoder 205.

In this embodiment, data has already been reproduced in the reproduction apparatus 100 according to the procedure shown in the program information, so that the control circuit 211 reproduces the data in regardless of a “begin” element in the program information.

Also, the reproduction apparatus 100 measures the reproduction time periods prescribed by the “dur”elements, and decides the boundaries between a plurality of data successively transmitted over the same channel is reproduced.

That is, in this embodiment, the video1 data, the video3 data, and the video5 data are successively transferred as “position 1” data, so that it is necessary to control the reproduction operation by detecting the boundaries between these data. In this embodiment, the reproduction time periods of the video1 data, video3 data, and video5 data are three, two, and two minutes, respectively. On detecting the start of receiving data reproduced by the reproduction apparatus 100 according to the program information, the control circuit 211 activates a timer to measure the time periods for reproducing the received data. According to the time periods described in the program information, the control circuit 211 detects the boundaries between the received data. For instance, at the point in time when three minutes have passed from the start of the data reception, the control circuit 211 determines that the video1 data is switched to the next video3 data.

Under the control by the control circuit 211, the decoder 205 decodes data outputted from the buffer memory 203 and outputs the decoded data to the display unit 207.

As described above, in this embodiment, a plurality of audio and moving picture file data are reproduced according to program information. The program information is transferred to a PC prior to the transfer of the reproduced audio and moving picture data via digital interfaces, and the PC (device on the reception side) detects the transferred audio and moving picture data using the program information.

Further, when audio and moving picture data is transferred, a plurality of source packets each containing a file are multiplexed into a single isochronous packet to be transferred. As a result, even if a plurality of files are simultaneously reproduced according to program information, it is possible to transfer these files via digital interfaces.

Accordingly, it becomes possible to transfer audio and moving picture files, which should be reproduced according to program information, via a digital interface and to reproduce the files according to the program information at an external device.

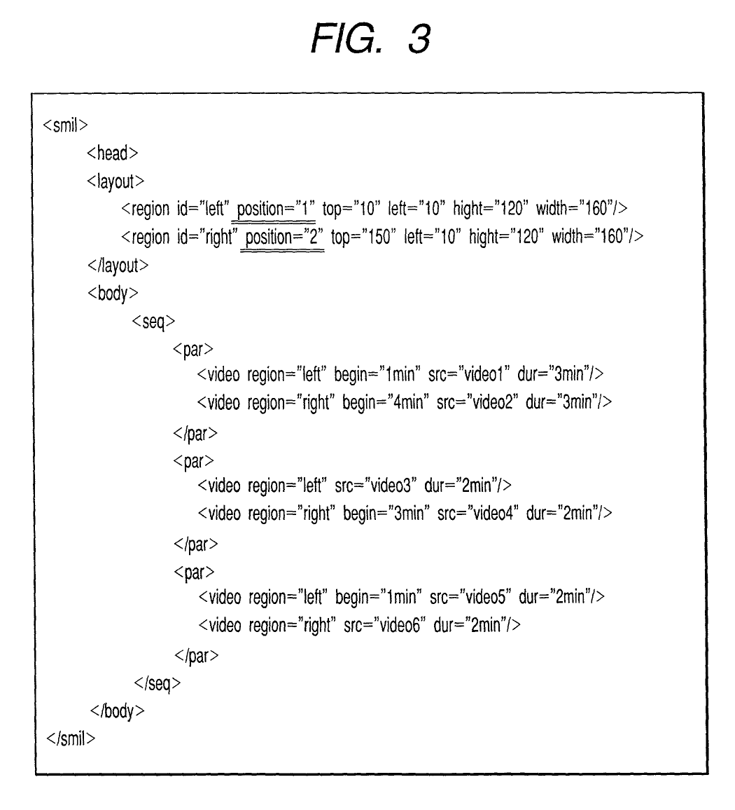

Note that, in this embodiment, when program information is transferred via a digital interface, this information is rewritten in the manner shown in FIG. 2 and then transferred. However, the present invention is not limited to this and the program information may be, for instance, rewritten in the manner shown in FIG. 3 where display regions correspond to information as to positions of source packets in the part between “<layout>” and “</layout>” in which the display regions are defined.

In the case of the program information shown in FIG. 3, each display region is given a definition of the position of source packets to be displayed in the display region. The PC 200 detects and decodes each source packet contained in the same isochronous packet according to this program information.

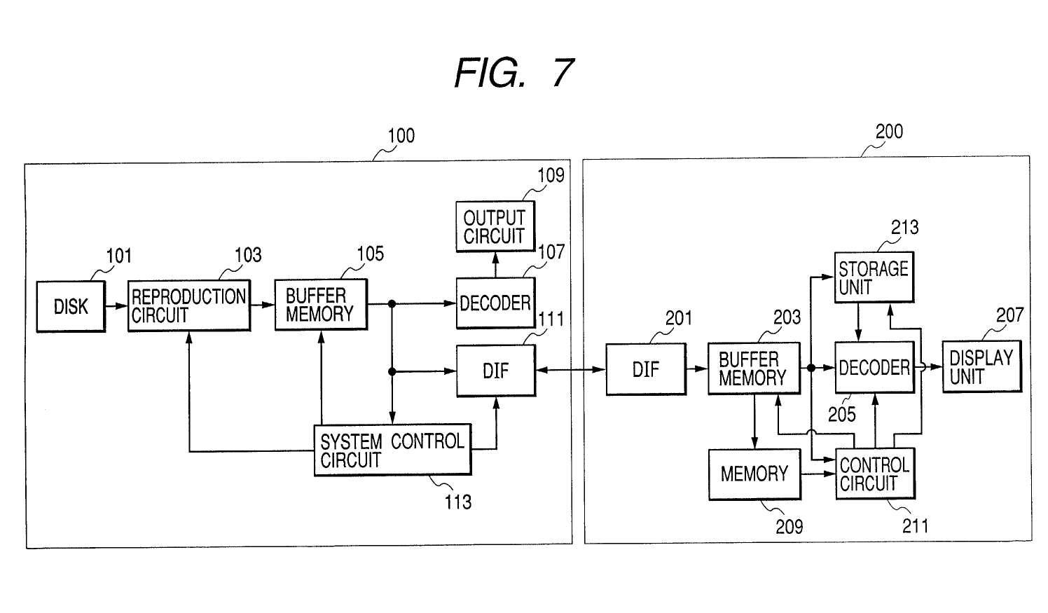

Next, the second embodiment of the present invention is described. FIG. 7 shows the construction of a reproduction system according to the second embodiment of the present invention.

In FIG. 7, the same elements as in FIG. 1 are indicated by the same reference numerals and the detailed description concerning such elements is omitted. In the second embodiment, data is reproduced by the reproduction apparatus 100 according to program information, the reproduced data is transferred via the DIFs 111 and 201, and the transferred data is decoded and displayed. In addition to these operations, in this second embodiment, data received by the DIF 201 is stored in a storage unit 213.

The storage unit 213 is realized using a mass storage medium, such as a hard disk (HDD), and stores data transferred from the DIF 201.

In this embodiment, the memory 209 stores the program information shown in FIG. 2 or FIG. 3 transferred from the reproduction apparatus 100 in the manner described above. However, even if data stored in the storage unit 213 is reproduced using the program information recorded in the memory 209 without changing it, the data cannot be reproduced in the same way as in the reproduction apparatus 100.

That is, data transferred from the reproduction apparatus 100 in accordance with the program information has already been reproduced in the reproduction apparatus 100 according to the procedure indicated by the program information. Consequently, if data stored in the storage unit 213 is reproduced using the “begin” values in the program information without changing it, the stored data is not properly reproduced.

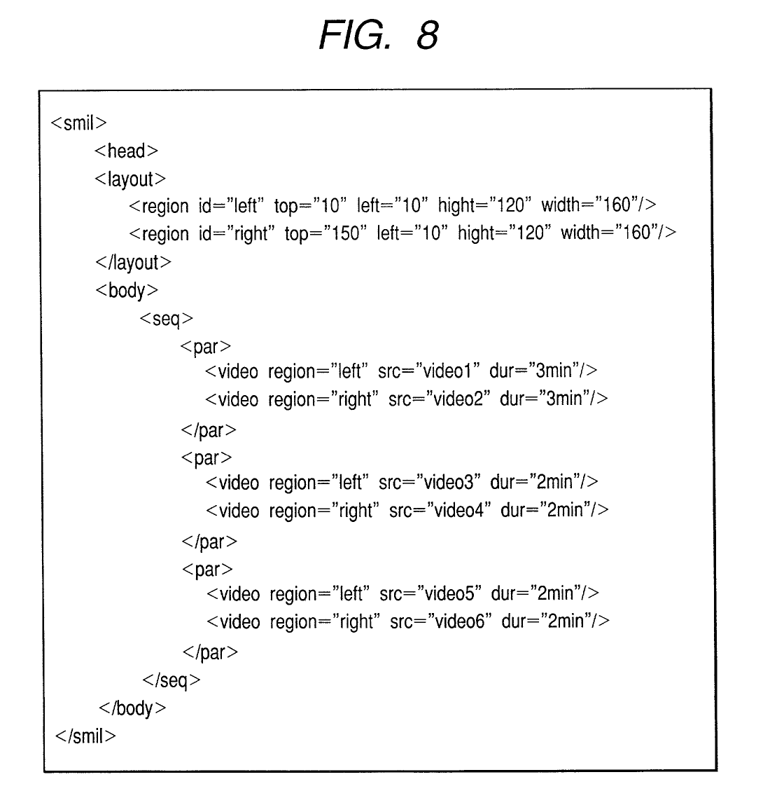

In view of this problem, after all data transferred from the reproduction apparatus 100 is stored in the storage unit 213, the control circuit 211 rewrites the program information recorded in the memory 209 in the manner shown in FIG. 8, and stores the rewritten information in the storage unit 213. The rewritten information stored in the storage unit 213 is related to the data stored in advance.

In more detail, as shown in FIG. 8, program information from which the “begin” element has been deleted is stored in the storage unit 213. Note that, during this operation, it is possible to change the name of each file in the PC 200 as appropriate.

As described above, in this embodiment, if data is reproduced by the reproduction apparatus according to program information, is transported via the DIFs, is stored in the storage unit, and is reproduced according to the program information transported after the data transmission, the contents of the transported program information are rewritten according to the procedure for reproducing the stored data. This allows the data stored in the storage unit to be properly reproduced according to the program information.

Next, the third embodiment of the present invention is described. The construction of a system of this embodiment is the same as that shown in FIG. 1 or FIG. 7 and its operation during ordinary reproduction is fundamentally the same as that of the system shown in FIG. 1 or FIG. 7.

The following is a description of how data is reproduced according to program information and is transferred to the PC via the DIFs in this embodiment.

When data is reproduced according to program information, the system control circuit 113 first secures an isochronous channel, which is necessary to output the reproduced data via the digital interface, by controlling the DIF 111. Therefore, the system control circuit 113 first checks the contents of program information recorded on the disk 101, reproduced by the reproduction circuit 103, and supplied via the buffer memory 105. The system control circuit 113 then checks the number of necessary channels and rewrites the contents of the program information.

In the case shown in FIG. 4, the maximum number of moving picture data (files) that should be simultaneously reproduced is two, so that the system control circuit 113 sets the number of necessary channels as two.

In the case of the isochronous transfer mode of the IEEE1394-1995 standard, channels numbered from 0 to 63 are used and each channel is secured by accessing a register managed by an IRM (isochronous resource manager) existing on a bus.

The system control circuit 113 refers to the contents of the register managed by this IRM to find which channels are currently unused. The system control circuit 113 then rewrites the value corresponding to each channel that is selected as a channel for transmitting reproduced data, and secures each selected channel by controlling the DIF 111. In this embodiment, two channels (channels numbers 1 and 2, for instance) are secured.

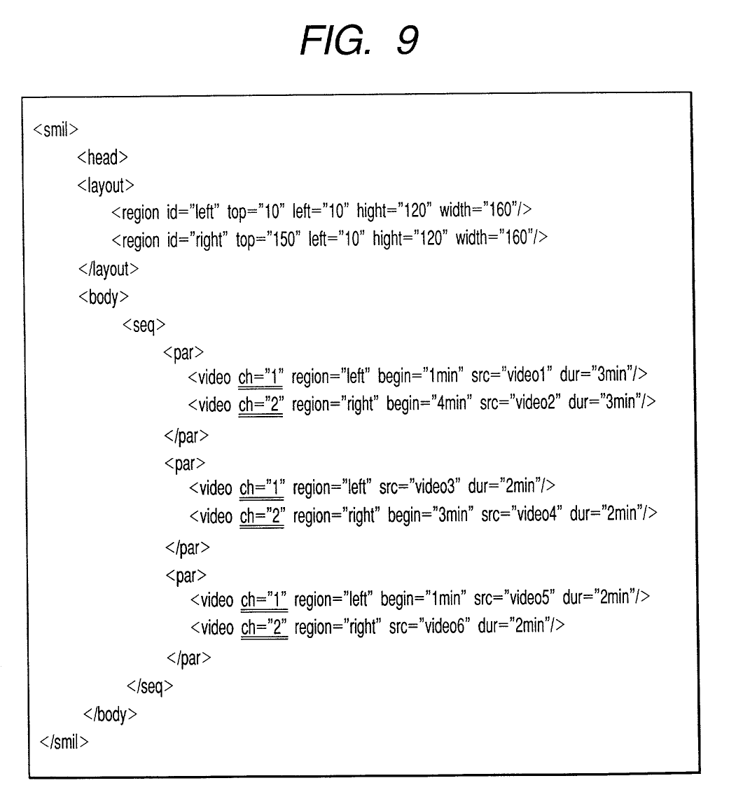

Further, the system control circuit 113 rewrites reproduced program information in the manner shown in FIG. 9. That is, the system control circuit 113 adds a “ch” element to a specified part of moving picture data. This “ch” element defines a transmission channel. Therefore, in FIG. 9, the “ch” element shows that the video1 data, video3 data, and video5 data should be transferred using the channel numbered 1 and the video2 data, video4 data, and video6 data should be transferred using the channel numbered 2.

After securing these channels, the system control circuit 113 rewrites the program information in the manner shown in FIG. 9, reads the rewritten program information stored in the buffer memory 105, and outputs the read program information to the DIF 111. After making a preparation for transferring the program information to the DIF 201 of the PC 200, the DIF 111 transfers the program information in the asynchronous transfer mode.

In the PC 200, the program information received by the DIF 201 is stored in the buffer memory 203. On detecting that the program information has been written into the buffer memory 203, the control circuit 211 stores the program information in the memory 209. The control circuit 211 then analyzes the contents of this program information and notifies the DIF 111 of the reproduction apparatus 100 that the analysis is completed via the DIF 201.

After transmitting the program information shown in FIG. 9, the system control circuit 113 waits for a notification that the analysis of the program information by the PC 200 is completed to be transmitted from the DIF 201. After receiving this notification, the system control circuit 113 starts to reproduce and transmit data according to the program information shown in FIG. 9.

In this embodiment, two moving picture data (moving picture files) are simultaneously reproduced. By controlling the DIF 111, the system control circuit 113 sets two source packets generated from these two moving picture data in different isochronous packets according to a procedure indicated by the program information, and transmits the packets.

Next, the DIF 201 of the PC 200 extracts a source packet from each received isochronous packet according to the program information received in advance, and outputs the extracted source packet to the buffer memory 203.

The control circuit 211 detects the contents of data stored in the buffer memory 203, selects necessary data according to the reproduction procedure indicated by the program information stored in the memory 209, and outputs the selected data to the decoder 205. In more detail, the video1 data, the video3 data, and the video 5 data are transferred over the channel numbered 1, and the video 2 data, the video 4 data, and the video6 data are transferred over the channel numbered 2. Therefore, the control circuit 211 detects these data and outputs the detected data to the decoder 205.

In this embodiment, data has already been reproduced in the reproduction apparatus 100 according to the procedure indicated by the program information, so that the control circuit 211 reproduces the data regardless of the “begin” element in the program information.

Also, the reproduction apparatus 100 measures the reproduction time periods prescribed by the “dur” elements reproduced, and detects the boundaries between a plurality of data successively transmitted over each channel.

That is, in this embodiment, data in the video1 file, video3 file, and video5 file is successively transferred over the channel numbered 1, so that it is necessary to control the reproduction operation by detecting the boundaries between these data. In this embodiment, the reproduction time periods of the video1 data, video3 data, and video5 data are three, two, and two minutes, respectively. On detecting the start of receiving data reproduced by the reproduction apparatus 100 according to the program information, the control circuit 211 activates a timer to measure the time periods for reproducing the received data. According to the time periods described in the program information, the control circuit 211 detects the boundaries between the received data. For instance, at the point in time when three minutes have passed from the start of the data reception, the control circuit 211 determines that video1 data is switched to the next video3 data.

Under the control by the control circuit 211, the decoder 205 decodes data outputted from the buffer memory 203 and outputs the decoded data to the display unit 207.

As described above, in this embodiment, a plurality of audio and moving picture file data are reproduced according to program information. The program information is transferred to a PC prior to the transfer of the reproduced audio and moving picture data via digital interfaces, and the PC (device on the reception side) detects the transferred audio and moving picture data using the program information.

Further, when a plurality of data is transferred, a plurality of channels that are necessary to simultaneously transfer these data are secured according to the contents of the program information, and the plurality of moving picture data specified by the program information are transferred over the secured channels. As a result, even if a plurality of files are simultaneously reproduced according to the program information, it is possible to transfer these files via a digital interface.

Accordingly, it becomes possible to transfer audio and moving picture files, which should be reproduced according to program information, via digital interfaces and to reproduce the files according to the program information at an external device.

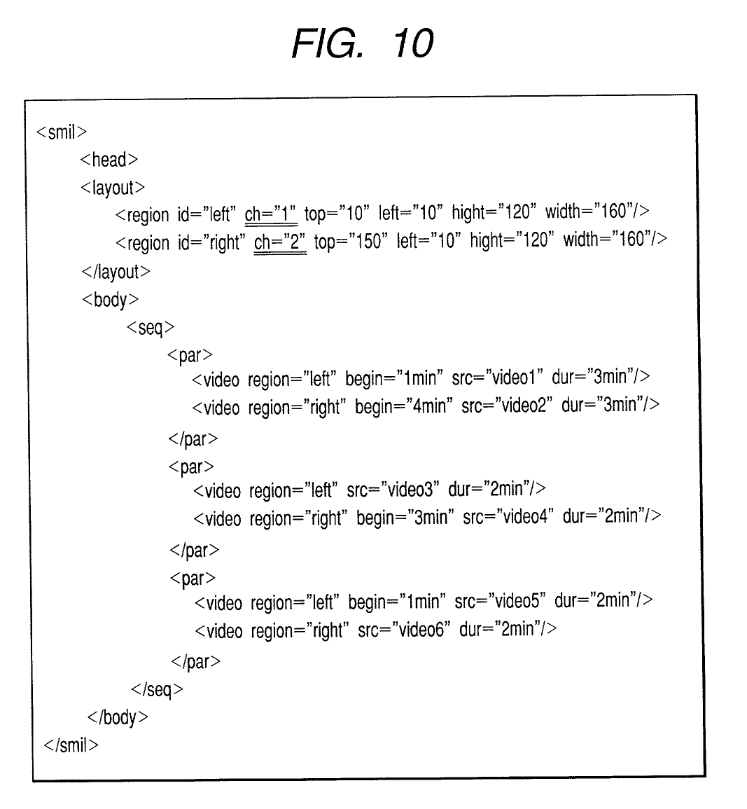

Note that, in this embodiment, when program information is transferred via digital interfaces, this information is rewritten in the manner shown in FIG. 9 and then transferred. However, the present invention is not limited to this and the program information may be, for instance, rewritten in the manner shown in FIG. 10 where display regions correspond to information as to of source packets in the part between “<layout>” and “</layout>” in which the display regions are defined.

In the case of the program information shown in FIG. 9, each display region is given a definition of the position of source packets to be displayed in the display region. The PC 200 detects and decodes source packets transferred over each channel according to this program information.

Furthermore, in this embodiment, in the case where data transferred from the reproduction apparatus 100 is stored in the storage unit 213 shown in FIG. 7 and is reproduced according to the program information recorded in the memory 209, even if the data stored in the storage unit 213 is reproduced using the program information without changing it, the data cannot be reproduced in the same way as in the reproduction apparatus 100. This problem is the same that described above in the second embodiment.

In view of this problem, as in the second embodiment, after all data transferred from the reproduction apparatus 100 is stored in the storage unit 213, the control circuit 211 rewrites the program information recorded in the memory 209 in the manner shown in FIG. 8, and stores the rewritten information in the storage unit 213. The rewritten information stored in the storage unit 213 is related to the data stored in advance. In this manner, if data is reproduced by the reproduction apparatus according to program information, is transported via the DIFS, is stored in the storage unit, and then is reproduced according to the program information transported after the data, the contents of the transported program information is rewritten according to the procedure for reproducing the stored data. This allows the data stored in the storage unit to be properly reproduced according to the program information.

It does not matter whether the present invention is applied to a system constructed using a plurality of devices (a host computer, an interface device, a reader, a printer, and the like, for instance) or to an apparatus composed of a single device.

Also, the present invention includes a case where software program code is generated to realize the functions described in the aforementioned embodiments by the operations of various devices, and then is supplied to a computer provided in a system or an apparatus connected to the various devices, and the various devices operate according to the program stored in the computer (CPU or MPU) of the system or the apparatus.

That is, it is possible to realize the aforementioned ordinary recording and reproduction operation for MPEG-2 TSs and the recording and reproduction processing of after-recorded audio data by performing software processing using a microcomputer.

Also, in this case, the software program code itself realizes the functions described in the aforementioned embodiments. Therefore, the present invention may be achieved by the program code itself. Also, the present invention may be achieved by a means for supplying the program code to a computer, such as a storage medium storing the program code. For instance, a floppy disk, a hard disk, an optical disk, a magneto-optical disk, a CD-ROM, a magnetic tape, a nonvolatile memory card, or a ROM may be used as the storage medium storing the program code.

Further, needless to say, in addition to the case where a computer realizes the functions described in the aforementioned embodiments by executing the supplied program code, the present invention includes a case where the program code realizes the functions described in the aforementioned embodiments in conjunction with an OS (operating system) or another application software running on the computer.

Also, the present invention includes a case where the supplied program code is stored in a memory provided on a feature expansion board of a computer or a feature expansion unit connected to the computer and then a CPU or the like of the feature expansion board or the feature expansion unit performs all or a part of actual processing according to the contents of the program code, thereby realizing the functions described in the aforementioned embodiments.

The invention may be embodied in other specific forms without departing from essential characteristics thereof.

Therefore, the above-described embodiments are merely exemplary of this invention, and are not be construed to limit the scope of the present invention.

The scope of the present invention is defined by the scope of the appended claims, and is not limited to only the specific descriptions in this specification. Furthermore, all the modifications and changes belonging to equivalents of the claims are considered to fall within the scope of the present invention.

What is claimed is:

1. A reproduction apparatus comprising:
reproduction means for reproducing digital moving picture data and program data recorded on a recording medium, the program data indicating a procedure for reproducing the digital moving picture data; and
digital interface means for outputting the digital moving picture data and the program data reproduced by said reproduction means to the external of said apparatus.

2. A reproduction apparatus according to claim 1 further comprising control means for controlling said digital interface means so that the digital moving picture data and the program data are outputted in a predetermined order.

3. A reproduction apparatus according to claim 2, wherein said control means controls said digital interface means so that the program data is first outputted and then the digital moving picture data is outputted.

4. A reproduction apparatus according to claim 3,
wherein said control means further controls said reproduction means so that the digital moving picture data is reproduced according to the procedure indicated indicated by the program data reproduced by said reproduction means, and
wherein said digital interface means outputs the digital moving picture data reproduced according to the program data.

5. A reproduction apparatus according to claim 3 or claim 4, wherein said control means changes contents of the program data, and controls said digital interface means so that the changed program data is outputted.

6. A reproduction apparatus according to claim 5, wherein said control means changes the contents of the program data according to the procedure indicated by the program data.

7. A reproduction apparatus according to claim 1 further comprising control means for controlling an output operation of the digital interface means according to contents of the reproduced program data.

8. A reproduction apparatus according to claim 7,
wherein said digital interface means is pursuant to an IEEE1394-1995 standard, and
wherein said control means determines a number of transfer channels, which are to be used by said digital interface means, according to the contents of the program data.

9. A reproduction apparatus according to claim 8,
wherein said control means changes the contents of the program data so that the program data indicates transfer channels over which the digital moving picture data is to be transferred, and
wherein said digital interface means outputs the program data whose contents have been changed.

10. A reproduction apparatus according to claim 7,
wherein said digital interface means is pursuant to an IEEE1394-1995 standard, and
wherein said control means determines a number of source packets, which are to be contained in a single isochronous packet, according to the contents of the program data.

11. A reproduction apparatus according to claim 10,
wherein said control means changes the contents of the program data so that the program data indicates a position of each source packet of the digital moving picture data within an isochronous packet, and
wherein said digital interface means outputs the program data whose contents have been changed.

12. A reproduction apparatus according to claim 1, wherein the digital moving picture data is transport stream data based on an MPEG-2 system standard.

13. A reproduction apparatus according to claim 1, wherein the program data is written in a SMIL format.

14. A reproduction apparatus according to claim 1 further comprising:
a decoder adapted to decode the digital moving picture data; and
an output unit adapted to output the decoded moving picture data to an external device.

15. An image processing apparatus comprising:
digital interface means for inputting program data and digital moving picture data, the program data indicating a procedure for reproducing the digital moving picture data, and the digital moving picture data having been reproduced according to the procedure indicated by the program data before being inputted;
processing means for processing the digital moving picture data inputted by said digital interface means; and
control means for controlling a processing operation of said processing means according to the program data inputted by said digital interface means.

16. An image processing apparatus according to claim 15, wherein said control means discriminates the digital moving picture data inputted by said digital interface means according to said program data, and controls the operation of the processing means according to a result of the distinguishing.

17. An image processing apparatus according to claim 16,
wherein said digital interface means is pursuant to an IEEE1394-1995 standard, and
wherein said control means detects a plurality of digital moving picture data contained in a single isochronous packet according to the program data.

18. An image processing apparatus according to claim 16,
wherein said digital interface means is pursuant to an IEEE1394-1995 standard, and
wherein said control means detects a plurality of digital moving picture data transferred over different transfer channels, according to the program data.

19. An image processing apparatus according to claim 15 further comprising:
recording means for recording the digital moving picture data on a storage medium,
wherein said control means changes contents of the program data according to the recorded digital moving picture data, and controls said processing means so that the recorded moving picture data is reproduced according to the changed program data.

20. An image processing apparatus according to claim 15, wherein the digital moving picture data is transport stream data based on an MPEG-2 system standard.

21. An image processing apparatus according to claim 15, wherein the program data is written in a SMIL format.

22. An image processing apparatus according to claim 15, wherein s aid processing means includes:
a decoder addapted to decode the digital moving picture data; and
an output unit adapted to output the decoded moving picture data to a display device.

23. A reproduction method comprising:
a step of reproducing digital moving picture data and program data recorded on a recording medium, the program data indicating a procedure for reproducing the digital moving picture data; and
a step of outputting the reproduced digital moving picture data and program data to the external of a reproducing apparatus via digital interface means.

24. An image processing method comprising:
a step of inputting program data and digital moving picture data via digital interface means, the program data indicating a procedure for reproducing the digital moving picture data, and the digital moving picture data having been reproduced according to the procedure indicated by the program data before being inputted; and
a step of processing the digital moving picture data inputted via said digital interface means according to the program data inputted via said digital interface means.
